(19) United States
(12) Patent Application Publication
(10) Pub. No.: US 2007/0200724 A1
(43) Pub. Date: Aug. 30, 2007

(54) Energy harvesting for mobile RFID readers

(75) Inventors: Philip Lazo, Mount Airy, MD (US); Mark Duron, East Patchogue, NY (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/363,277

(22) Filed: Feb. 28, 2006

(51) Int. Cl. G08B 23/00; G08B 13/14

(52) U.S. Cl. 340/693.1; 340/572.1

(57) ABSTRACT

Methods, systems, and apparatuses for providing power to a radio frequency identification (RFID) reader on a mobile structure are described. Energy is generated at the mobile structure. A battery or other energy storage device disposed on the mobile structure is charged with the generated energy. The RFID reader is powered with the energy storage device. The energy may be generated in a variety of ways, including using a vibratory energy harvesting device, a magnetic energy harvesting device, an optical energy harvesting device, a heat energy harvesting device, or a mechanical energy harvesting device.

### BACKGROUND OF THE INVENTION

1. Field of the Invention

The invention relates to radio frequency identification (RFID) readers, and in particular, to generating energy used to power mobile RFID readers.

2. Background Art

Radio frequency identification (RFID) tags are electronic devices that may be affixed to items whose presence is to be detected and/or monitored. The presence of an RFID tag, and therefore the presence of the item to which the tag is affixed, may be checked and monitored wirelessly by devices known as “readers.” Readers typically have one or more antennas transmitting radio frequency signals to which tags respond. Because the reader “interrogates” RFID tags, and receives signals back from the tags in response to the interrogation, the reader is sometimes termed a “reader interrogator” or simply “interrogator.”

With the maturation of RFID technology, efficient communication between tags and interrogators has become a key enabler in supply chain management, especially in manufacturing, shipping, and retail industries, as well as in building security installations, healthcare facilities, libraries, airports, warehouses etc.

Reading of tags in a warehouse environment may be performed by a reader mounted to a forklift, or by other mobile warehouse machinery. A variety of forklifts exist in industry, and thus a variety of reader configurations are necessary to accommodate the various forklifts. Readers can be mounted to forklifts in a variety of locations, including being mounted to a fork of the forklift. Cabling is typically used to provide power to the forklift fork-mounted readers. Power cabling connected between a forklift fork-mounted reader and a power source on the forklift can be a source of reliability problems. For example, the power cabling running from the movable fork assembly to the main power source of the forklift is subject to repeated bending and straightening as the forks are accuated up, down, left and right. This can lead to tangling and wear of the cable assembly. Due to these difficulties, it is desirable to have a forklift-mounted reader that is small in form factor and is battery powered to eliminate the need for power cabling. However, the power requirements for a forklift-mounted reader are high. For example, a reader may transmit 1 W of radiated power over a full 8 hour work shift in an industrial environment. Because of this, a forklift fork-mounted reader would require a battery with large energy storage capacity.

Thus, what is needed are improved ways of providing power to RFID readers on movable structures, such as forklift fork assemblies.

### BRIEF SUMMARY OF THE INVENTION

Methods, systems, and apparatuses for powering radio frequency identification (RFID) readers on movable structures are described. Energy is generated at the mobile structure. The generated energy is stored and used to power the reader on the mobile structure.

In an example aspect of the present invention, energy is generated at the mobile structure. An energy storage device, such as a battery, is disposed on the mobile structure is charged with the generated energy. The RFID reader is powered with the energy storage device.

In aspects, the energy may be generated by a variety of energy harvesting devices, including a vibratory energy harvesting device, a magnetic energy harvesting device, an optical energy harvesting device, a heat energy harvesting device, or a mechanical energy harvesting device.

In an example aspect, a vibratory energy harvesting device generates the energy from vibration of the mobile structure during operation of the mobile structure.

In a further example aspect, the vibratory energy harvesting device comprises a piezoelectric transducer. In an example implementation, a moment arm mounts the piezoelectric transducer. A capacitor is coupled to the energy storage device. Vibration of the arm causes the arm to deflect the piezoelectric transducer. The piezoelectric transducer generates a current due to the deflection. The current charges the capacitor.

In another example aspect, a magnetic energy harvesting device generates the energy from magnetism related to the movement of the mobile structure.

In a further example aspect, the magnetic energy harvesting device includes a magnet and a coil. The energy is generated by movement of the magnet with respect to the coil.

In another example aspect, an optical energy harvesting device includes an optical-to-electrical transducer that converts light received at the mobile structure into energy.

In another example aspect, a heat energy harvesting device converts heat generated by operation of the mobile structure into energy.

In another example aspect, a mechanical energy harvesting device converts friction due to operation of the mobile structure into energy. In another example aspect, the mechanical energy harvesting device uses a rotational wheel mechanism that rotates due to movement of the mobile structure to generate energy.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows an environment where RFID readers communicate with an exemplary population of RFID tags.

FIG. 2 shows a block diagram of receiver and transmitter portions of a RFID reader.

FIGS. 3A and 3B shows front and side views, respectively, of a mobile structure that carries a reader.

FIGS. 4 and 6 show energy producing systems for readers on mobile structures, according to example embodiments of the present invention.

FIG. 5 shows an example flowchart for powering a reader on a mobile structure, according to an example embodiment of the present invention.

FIG. 7 shows a vibratory energy harvesting device, according to an example embodiment of the present invention.

FIG. 8 shows a energy harvesting device that includes a piezoelectric transducer, according to an example embodiment of the present invention.

FIG. 9 shows a circuit for harvesting energy from a piezoelectric transducer.

FIG. 10 shows a magnetic energy harvesting device, according to an example embodiment of the present invention.

FIG. 11 shows a circuit for harvesting energy using a magnet and coil, according to an example embodiment of the present invention.

FIG. 12 shows an optical energy harvesting device, according to an example embodiment of the present invention.

FIG. 13 shows a heat energy harvesting device, according to an example embodiment of the present invention.

FIG. 14 shows a mechanical energy harvesting device, according to an example embodiment of the present invention.

FIGS. 15 and 16 show example embodiments of the mechanical energy harvesting device of FIG. 14.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

Introduction

Methods, systems, and apparatuses for RFID devices, such as readers, are described herein. Furthermore, methods, systems, and apparatuses for improved powering of readers are described.

Supplying power to RFID readers located in real world installations can be difficult, particularly when the readers are attached to movable structures such as forklift forks. Running a power cable from the forklift batteries to a reader mounted on a movable structure provides problems in the work environment. The power cable may be damaged by wear associated with the movement and actuation of the structure A battery may be mounted to the mobile structure to avoid the need for a power cable. However, readers require a large amount of power to perform RF communications, and thus require large batteries.

Embodiments of the present invention overcome problems with powering readers present in conventional systems. For example, according to embodiments, energy is generated on the mobile structure on which the reader is disposed, such as in the form of electrical energy. The energy is stored on the mobile structure, and used to power the reader. In this manner, the need for replacement of batteries, battery charging cycle times, power cables, and/or extremely large batteries is reduced or eliminated.

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “down,” “top,” “bottom,” “vertical,” “horizontal,” etc.) used herein are for purposes of illustration only, and that practical implementations of the structures described herein can be spatially arranged in any orientation or manner.

Example RFID System Embodiment

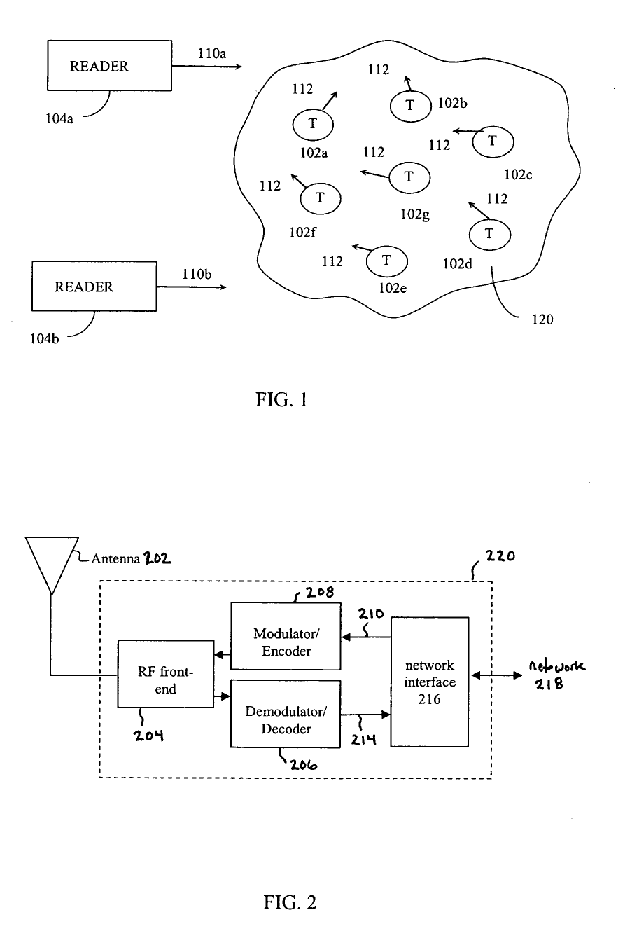

Before describing embodiments of the present invention in detail, it is helpful to describe an example RFID communications environment in which the invention may be implemented. FIG. 1 illustrates an environment 100 where RFID tag readers 104 communicate with an exemplary population 120 of RFID tags 102. As shown in FIG. 1, the population 120 of tags includes seven tags 102a-102g. A population 120 may include any number of tags 102.

Environment 100 includes any number of one or more readers 104. For example, environment 100 includes a first reader 104a and a second reader 104b. Readers 104a and/or 104b may be requested by an external application to address the population of tags 120. Alternatively, reader 104a and/or reader 104b may have internal logic that initiates communication, or may have a trigger mechanism that an operator of a reader 104 uses to initiate communication. Readers 104a and 104b may also communicate with each other in a wired or wireless reader network.

As shown in FIG. 1, reader 104a transmits an interrogation signal 110 having a carrier frequency to the population of tags 120. Reader 104b transmits an interrogation signal 110b having a carrier frequency to the population of tags 120. Readers 104a and 104b typically operate in one or more of the frequency bands allotted for this type of RF communication. For example, frequency bands of 902-928 MHz and 2400-2483.5 MHz have been defined for certain RFID applications by the Federal Communication Commission (FCC).

Various types of tags 102 may be present in tag population 120 that transmit one or more response signals 112 to an interrogating reader 104, including by alternatively reflecting and absorbing portions of signal 110 according to a time-based pattern or frequency. This technique for alternatively absorbing and reflecting signal 110 is referred to herein as backscatter modulation. Readers 104a and 104b receive and obtain data from response signals 112, such as an identification number of the responding tag 102. In the embodiments described herein, a reader may be capable of communicating with tags 102 according to any suitable communication protocol, including Class 0, Class 1, EPC Gen 2, other binary traversal protocols and slotted aloha protocols, any other protocols mentioned elsewhere herein, and future communication protocols.

FIG. 2 shows a block diagram of a receiver and transmitter portion 220 of an example RFID reader 104. Reader 104 includes one or more antennas 202, a RF front-end 204, a demodulator/decoder 206, a modulator/encoder 208, and a network interface 216. These components of reader 104 may include software, hardware, and/or firmware, or any combination thereof, for performing their functions.

Reader 104 has at least one antenna 202 for communicating with tags 102 and/or other readers 104. RF front-end 204 may include one or more antenna matching elements, amplifiers, filters, an echo-cancellation unit, a down-converter, and/or an up-converter. RF front-end 204 receives a tag response signal through antenna 202 and down-converts (if necessary) the response signal to a frequency range amenable to further signal processing. Furthermore, RF front-end 204 receives a modulated encoded interrogation signal from modulator/encoder 208, up-converts (if necessary) the interrogation signal, and transmits the interrogation signal to antenna 202 to be radiated.

Antenna(s) 202 may be any type of reader antenna known to persons skilled in the relevant art(s). For description of an example antenna suitable for reader 104, refer to U.S. Ser. No. 11/265,143, filed Nov. 3, 2005, titled “Low Return Loss Rugged RFID Antenna,” now pending, which is incorporated by reference herein in its entirety.

Demodulator/decoder 206 is coupled to an output of RF front-end 204, receiving a modulated tag response signal from RF front-end 204. Demodulator/decoder 206 demodulates the tag response signal. For example, the tag response signal may include backscattered data encoded according to FMO or Miller encoding formats. Demodulator/decoder 206 outputs a decoded data signal 214. Decoded data signal 214 may be further processed in reader 104. Additionally or alternatively, decoded data signal 214 may be transmitted to a subsequent computer system for further processing.

Modulator/encoder 208 is coupled to an input of RF front-end 204, and receives an interrogation request 210. Modulator/encoder 208 encodes interrogation request 210 into a signal format, such as one of FM0 or Miller encoding formats, modulates the encoded signal, and outputs the modulated encoded interrogation signal to RF front-end 204.

In an embodiment, reader 104 includes network interface 216 to interface reader 104 with a communications network 218. When present, network interface 216 is used to provide interrogation request 210 to reader 104, which may be received from a remote server coupled to communications network 218. Furthermore, network interface 216 is used to transmit decoded data signal 214 from reader 104 to a remote server coupled to communications network 218. In embodiments, network interface 216 enables a wired and/or wireless connection with communications network 218. For example, network interface 216 may enable a wireless local area network (WLAN) link (including a IEEE 802.11 WLAN standard link), a BLUETOOTH link, and/or other types of wireless communication links. Communications network 218 may be a local area network (LAN), a wide area network (WAN) (e.g., the Internet), and/or a personal area network (PAN).

In further embodiments, alternative mechanisms for initiating an interrogation request may be present in reader 104. For example, reader 104 may include a finger-trigger mechanism, a keyboard, a graphical user interface (GUI), and/or a voice activated mechanism with which a user of reader 104 may interact to initiate an interrogation by reader 104.

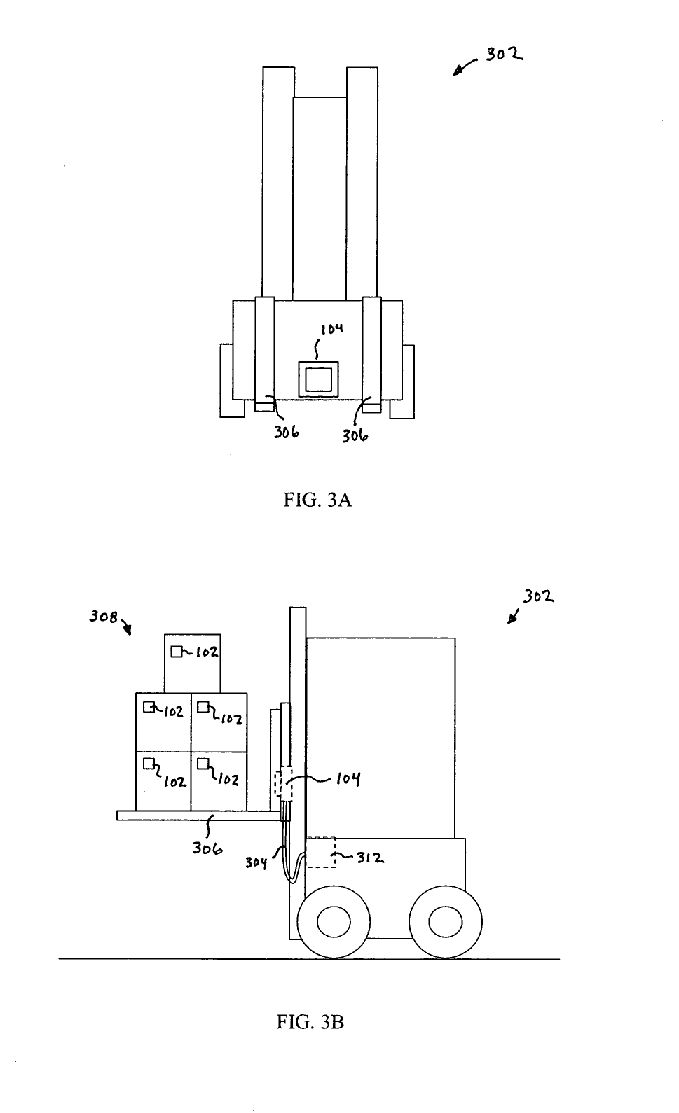

In an operational environment for a reader, the reader may be disposed on a mobile structure such as a forklift. For example, FIGS. 3A and 3B show views of a forklift 302 that mounts a reader 104. FIG. 3A shows a front view of forklift 302, with forks 306 of forklift 302 at a near bottom position. FIG. 3B shows a side view of forklift 302, with forks 306 raised to a middle position (with respect to FIG. 3A) and supporting a load of objects 308. As shown in FIG. 3B, each of objects 308 has a respective tag 102 attached thereto.

As shown in FIGS. 3A and 3B, reader 104 can be mounted in an unprotected location between forks 306 of forklift 302 (e.g., in the “load back rest” area), to be advantageously close to objects 308, for reading of tags 102 associated with objects 308.

As described above, components of reader 104, such as the components shown for receiver and transmitter portion 220 in FIG. 2, require power. Thus, as shown in FIG. 3B, a power cable 304 is connected between forklift power source 312 and reader 104. However, the presence of power cable 304 causes reader 104 and forklift 302 to suffer from the disadvantages described above, including limited range and reliability related issues.

As further described below, according to embodiments of the present invention, energy is generated on the mobile structure on which the reader is disposed. The generated energy is stored on the mobile structure, and used to power the reader. In this manner, the need for power cables and/or extremely large batteries with regard to mobile structures is reduced or eliminated.

Embodiments of the present invention are described in further detail below. Such embodiments may be implemented in environment 100 shown in FIG. 1, with reader 104 shown in FIG. 2, and/or in alternative environments and RFID devices.

Example Reader Powering Embodiments

Energy harvesting systems are described herein for providing energy to readers. Embodiments for the energy harvesting systems can be implemented anywhere that readers are used. For example, systems can be implemented in a commercial or industrial environment, such as in a warehouse, a factory, a business, or store, and in a military or other non-commercial environment. Furthermore, readers with energy harvesting systems may be attached to a stationary structure or to a mobile structure. The energy generating systems enable deployment of readers without the need for power cables and with potentially less space required for batteries.

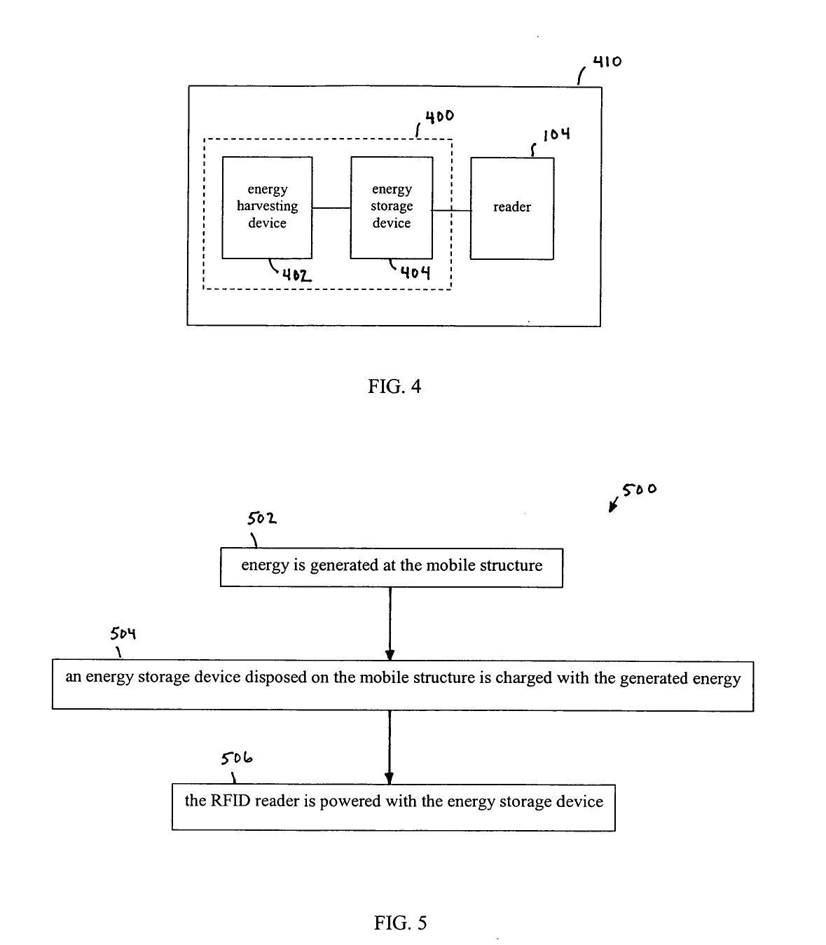

FIG. 4 shows a block diagram of an example reader powering system 400 disposed on a mobile structure 410, according to an embodiment of the present invention. Examples of mobile structure 410 include forklifts (e.g., as in FIGS. 3A-3B), warehouse box crushers, conveyor belts, cars, trucks, etc. Reader powering system 400 is coupled to reader 104, and generates and supplies power to reader 104. As shown in FIG. 4, system 400 includes an energy harvesting device 402 and a energy storage device 404. Energy harvesting device 402 is coupled to energy storage device 404, and energy storage device 404 is coupled to reader 104.

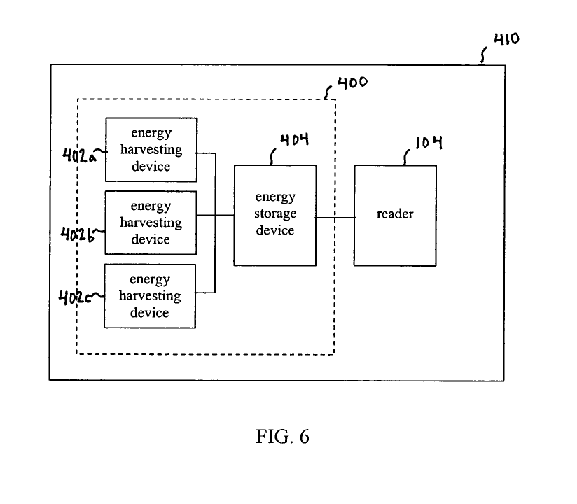

Detailed operation of system 400 is described with respect to FIG. 5. FIG. 5 shows a flowchart 500 providing example steps for providing power to a reader according to system 400. Other structural and operational embodiments will be apparent to persons skilled in the relevant art(s) based on the following discussion. The steps shown in FIG. 5 do not necessarily have to occur in the order shown.

Flowchart 500 begins with step 502. In step 502, energy is generated at the mobile structure. For example, in the embodiment of FIG. 4, energy harvesting device 402 generates the energy at mobile structure 410. In embodiments, energy harvesting device 402 may generate energy in different ways, some examples of which are described in further detail below. Energy harvesting device 402 is disposed on mobile structure 410, including being carried by, mounted on, or directly attached to mobile structure 410.

In step 504, an energy storage device disposed on the mobile structure is charged with the generated energy. For example, energy storage device 404 receives and stores the energy generated by energy harvesting device 402. Thus, energy storage device 404 is typically a rechargeable battery type, but may alternatively be another type of battery or storage device otherwise known or future developed that can receive and store energy. Example materials/battery types for a rechargeable battery include Lithium (e.g., Li-ion, Li-polymer), Nickel-Cadmium (NiCD), Nickel-Metal Hydride (NiMH), Zinc-air, or other material. Further examples for energy storage device 404 include fuel cells, nano-enabled energy storage materials, capacitors, inertial energy storage devices, or other energy storage devices. In an embodiment, energy is transferred to energy storage device 404 from energy harvesting device 402 in the form of an electric current over a suitable wire, cable, or bundle of wires and/or cables. Energy storage device 404 is disposed on mobile structure 410, including being carried by, mounted on, or directly attached to mobile structure 410.

In step 506, the RFID reader is powered with the energy storage device For example, reader 104 receives an electric current over a suitable wire, cable, or bundle of wires and/or cables from energy storage device 404. Reader 104 can be any type of reader, and can be powered in a conventional (or special purpose) manner by energy storage device 404.

As noted above, energy can be generated at mobile structure 410 in a variety of ways. For example, a single energy harvesting device 402 can be used to generate the energy, as shown in FIG. 4. Alternatively, a plurality of energy harvesting devices can be coupled in parallel and/or in series to generate energy. For example, FIG. 6 shows three energy harvesting devices 402a-402c coupled in parallel to generate energy that is input to energy storage device 404. Any number of energy harvesting devices 402 can be present in system 400, including numbers in the 10 s, 100 s, 1000 s, and even more energy harvesting devices 402, depending on the particular implementation.

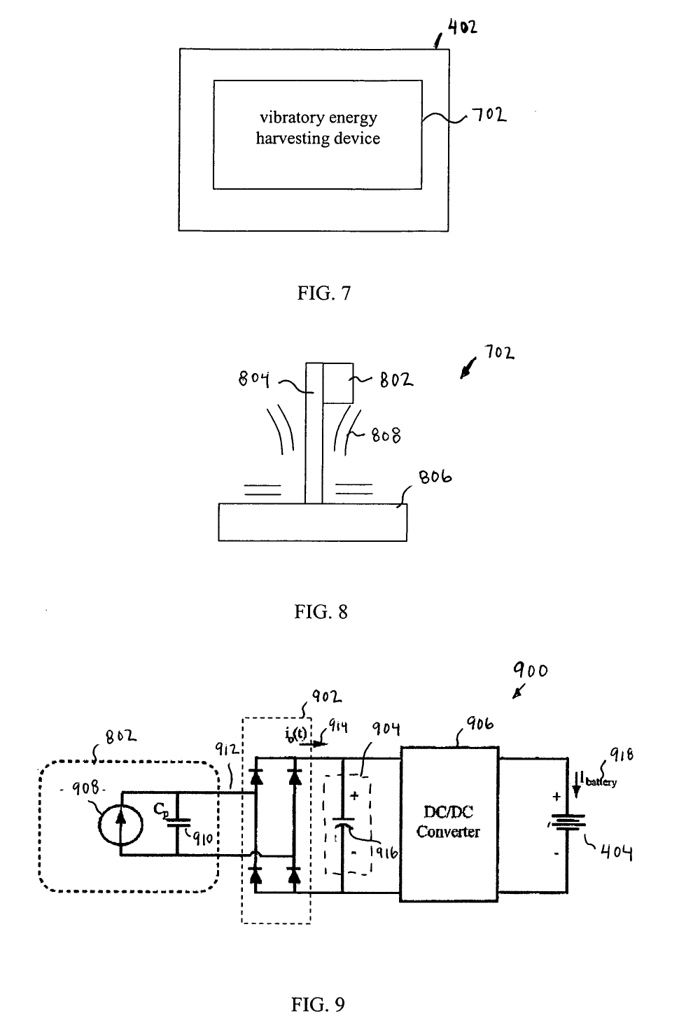

In embodiments, different types of energy harvesting devices can be used. For example, FIG. 7 shows energy harvesting device 402 including a vibratory energy harvesting device 702, according to an example embodiment of the present invention. Vibratory energy harvesting device 702 converts a vibration of mobile structure 410 into energy. For example, when mobile structure 410 is a forklift, such as forklift 302 shown in FIGS. 3A and 3B, the vibration of the forklift that occurs during normal operation (e.g., due to engine operation, etc.) is converted into energy by vibratory energy harvesting device 702. Vibratory energy harvesting device 702 can include a variety of vibration sensing/converting mechanisms, including piezoelectric transducers, magnets, and other mechanisms.

For example, FIG. 8 shows an example of a vibratory energy harvesting device 702 that incorporates a piezoelectric material, according to an embodiment of the present invention. Piezoelectric materials exhibit a “piezoelectric effect,” such that when they are subjected to a compressive or tensile stress, an electric field is generated across the material, creating a voltage gradient and subsequent current flow. Example suitable piezoelectric materials include polyvinylidene fluoride (PVDF) and lead zirconate titanate (PZT).

FIG. 8 shows a piezoelectric transducer 802 attached to a moment arm 804. Moment arm 804 is attached to a base 806, which may be mobile structure 410, some portion thereof, or a mount attached thereto. When mobile structure 410 vibrates, moment arm 804 undergoes a vibration 808. Moment arm 804 responds to vibration 808 by deflecting piezoelectric transducer 802. Piezoelectric transducer 802 converts this mechanical deflection to a voltage gradient that charges a storage device, such as a capacitor, that ultimately provides a trickle charge to energy storage device 404.

FIG. 9 shows an example circuit 900 for harvesting energy in system 400 that uses piezoelectric transducer 802. As shown in FIG. 9, circuit 900 includes piezoelectric transducer 802, a rectifier portion 902, a filter 904, a DC-DC converter 906, and energy storage device 404. Piezoelectric transducer 802 is represented in FIG. 9 by an equivalent circuit including a current source 908 and parallel capacitance 910.

Piezoelectric transducer 802 outputs an AC (alternating current) current signal 912 due to the piezoelectric effect caused by vibration 808. Rectifier portion 902 converts AC current signal 912 from piezoelectric transducer 802 into a DC (direct current) current signal 914. For example, rectifier portion 902 may include one or more diodes arranged in a rectifier configuration, as shown in FIG. 9. Filter 904 filters DC current signal 914. For example, filter 904 may include a capacitor 916, as shown in FIG. 9. A DC voltage across capacitor 916 is input to DC-DC converter 906. DC-DC converter 906 receives DC current signal 914 and outputs a desired DC voltage and a battery current 918 that is input to energy storage device 404. Battery current 918 charges energy storage device 404.

For further description regarding piezoelectric transducers and circuit 900, refer to Katz, Andrew, “Residential Piezoelectric Energy Sources,” Delta Smart House, Jul. 21, 2004 (all pages) (http://delta.pratt.duke.edu/downloads/piezoelectrics_andrew.doc), which is incorporated by reference herein in its entirety.

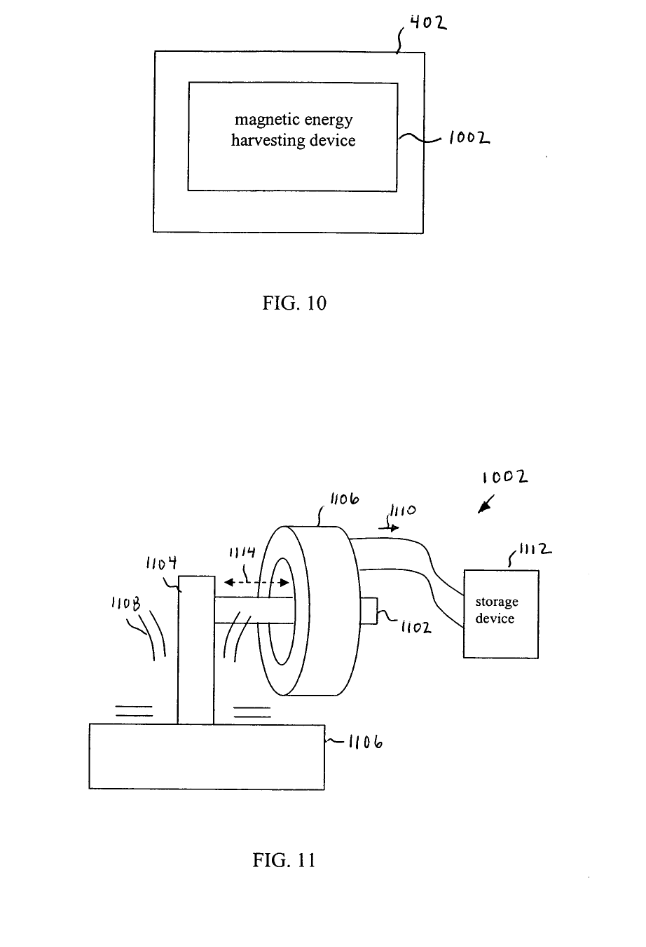

In another embodiment, FIG. 10 shows energy harvesting device 402 including a magnetic energy harvesting device 1002. Magnetic energy harvesting device 1002 utilizes magnetism, such as through the presence of a magnetic material, to generate energy to charge energy storage device 404. Magnetic energy harvesting device 1002 can be configured in a variety of ways to use magnetism to generate energy. For example, one or more magnets can be positioned near a coil of wire. When vibrations (such as due to operation of mobile structure 410) move the coil to move in the magnetic field generated by the magnet(s), a current is generated in the wire of the coil.

For instance, FIG. 11 shows an example of magnetic energy harvesting device 1002, according to an embodiment of the present invention. In FIG. 11, a magnet 1102 is attached to a moment arm 1104. Moment arm 1104 is attached to a base 1106, which may be mobile structure 410, some portion thereof, or a mount attached thereto. When mobile structure 410 vibrates, moment arm 1104 undergoes a vibration 1108. Moment arm 1104 responds to vibration 1108 by deflecting magnet 1102 through a coil 1106 (as indicated by arrow 1114). Movement of magnet 1102 through coil 1106 induces a current 1110 that provides a trickle charge to a storage device 1112. Storage device 1112 can be an intermediate storage element, such as one or more capacitors, for holding charge prior to transfer to energy storage device 404, or may be energy storage device 404 itself. The configuration of FIG. 11 may also be referred to as a “Faraday charger.”

Note that because vibration is used in part to generate energy in the configuration of magnetic energy harvesting device 1002 shown in FIG. 11, the configuration of FIG. 11 can also be considered as an embodiment of vibratory energy harvesting device 702.

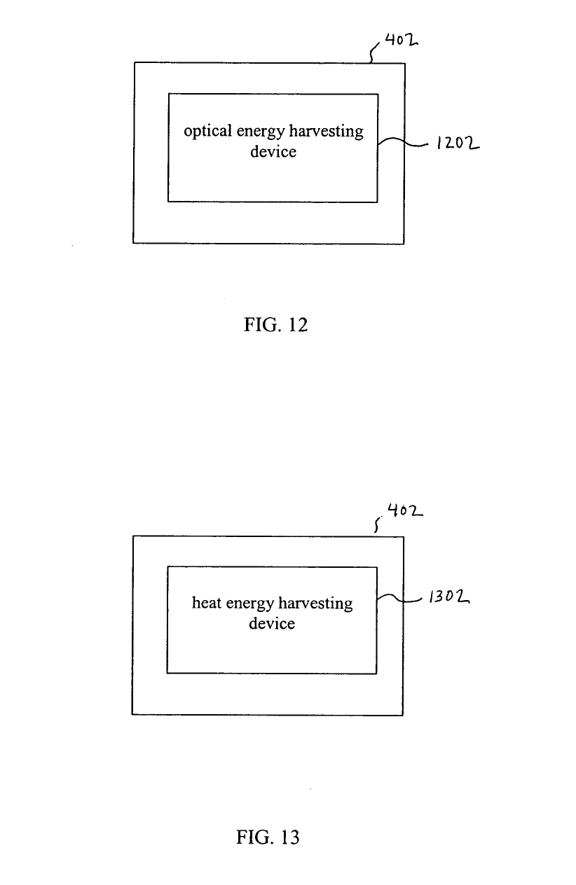

FIG. 12 shows energy harvesting device 402 including an optical energy harvesting device 1202, according to another example embodiment of the present invention. Optical energy harvesting device 1202 converts light received by optical energy harvesting device 1202 at mobile structure 410 into a current, to generate energy to charge energy storage device 404. Optical energy harvesting device 1202 can incorporate a variety of optical energy harvesting materials/devices to generate energy. For example, optical energy harvesting device 1202 may include optical-to-electrical transducers such as solar cells (or photovoltaic cells) to convert light to energy, photodiodes, optoelectronic transducers, other light sensitive elements that convert light to a current, and any other optical energy harvesting materials/devices known to persons skilled in the relevant art(s). The optical-to-electrical transducers may be positioned on mobile structure 410 such that solar and/or other light energy is received in sufficient quantities to generate a charging current.

FIG. 13 shows energy harvesting device 402 including a heat energy harvesting device 1302, according to another example embodiment of the present invention. Heat energy harvesting device 1302 converts heat present at mobile structure 410 into a current, to generate energy to charge energy storage device 404. For example, heat generated by operation of mobile structure 410, such as heat generated by an engine (when present) of mobile structure 410, may be utilized to generate a current to charge energy storage device 404. Heat energy harvesting device 1202 can incorporate a variety of heat energy harvesting materials/devices to generate energy. For example, materials/devices that utilize the Peltier-Seebeck effect or thermoelectric effect, may be used in heat energy harvesting device 1302. Alternatively, materials/devices utilizing the thermionic effect may be used, and/or any other heat energy harvesting materials/devices known to persons skilled in the relevant art(s).

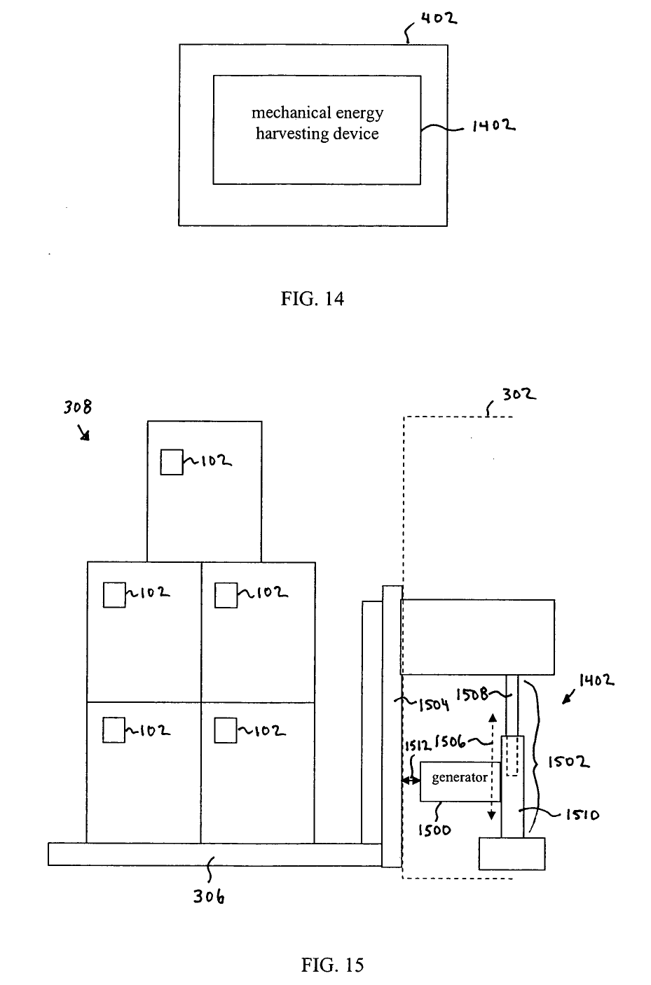

In another embodiment, FIG. 14 shows energy harvesting device 402 including a mechanical energy harvesting device 1402. Mechanical energy harvesting device 1402 utilizes mechanical motions and/or interactions, such rotation of a wheel and/or friction, to generate energy that can be used to charge energy storage device 404. Mechanical energy harvesting device 1402 can be configured in a variety of ways to use mechanical motions and interactions to generate energy.

For example, FIG. 15 shows an example of a mechanical energy harvesting device 1402 that utilizes friction to generate energy, according to an embodiment of the present invention. In the embodiment of FIG. 15, device 1402 includes a generator 1500. FIG. 15 further shows a portion of forklift 302, including forks 306 supporting a load of objects 308, and a telescoping riser 1502. Riser 1502 of forklift 302 is used to raise and lower forks 306 of forklift 302, as would be known to persons skilled in the relevant art(s), such as in hydraulic manner. For example, forks 306 may be mounted to a carriage 1504 of forklift 302. Carriage 1504 moves vertically along a mast (not shown in FIG. 15) of the forklift. Telescoping riser 1502 expands and contracts along an axis 1506 to move carriage 1504 and forks 306 upward and downward along the mast. In the example of FIG. 15, a first portion 1508 of telescoping riser 1504 moves in and out of a second portion 1510 of telescoping riser 1504, which remains stationary, to move carriage 1504 and forks 306 upward and downward. However, other configurations may be used, as would be apparent to persons skilled in the relevant art(s).

In the example of FIG. 15, generator 1500 is attached to second portion 1510 of telescoping riser 1502, which is stationary relative to carriage 1504. Furthermore, generator 1500 is positioned adjacent to carriage 1504 (and/or forks 306). An interface of generator 1500 interacts with (e.g., rubs) carriage 1504 as carriage 1504 is moved up and down along axis 1506. This interaction creates friction (indicated as friction 1512 in FIG. 15), which generator 1500 converts into energy (such as in an electrostatic energy generation manner), which can be stored in energy storage device 404.

The implementation of FIG. 15 may be modified to incorporate a track and gear arrangement. For example, a track may be formed on carriage 1504 (and/or on forks 306), along which a gear coupled to generator 1500 may ride when carriage 1504 is moved up and down along axis 1506. The turning of the gear may be used in generator 1500 to generate electricity (such as by using friction and/or using electromagnetic principles) that can be stored in energy storage device 404.

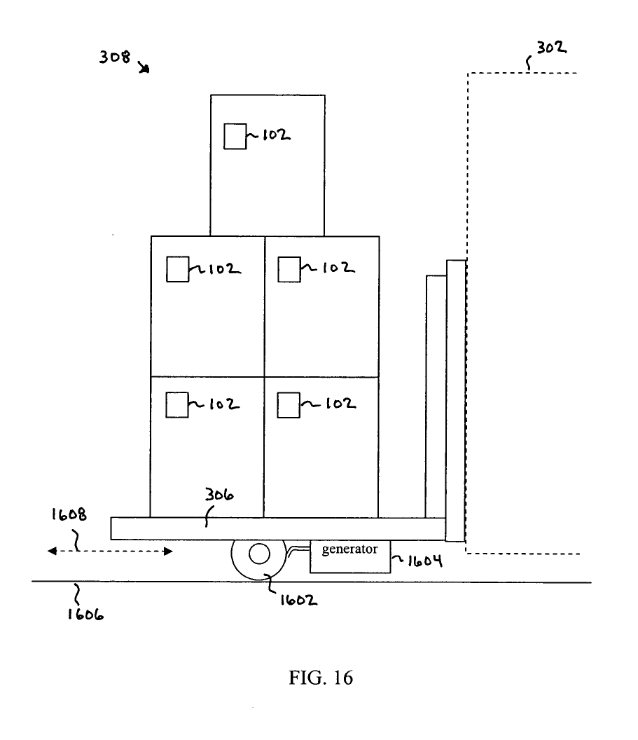

In another configuration, FIG. 16 shows an example of a mechanical energy harvesting device 1402 that utilizes a wheel 1602 to generate energy, according to an embodiment of the present invention. In the embodiment of FIG. 16, device 1402 includes a generator 1604 coupled to wheel 1602. FIG. 16 further shows a portion of forklift 302, including forks 306 supporting a load of objects 308. Generator 1604 is shown mounted to forks 306 in FIG. 16, but can be located in other locations on forklift 302. Wheel 1602 is also mounted to forks 306. A bottom surface of wheel 1602 is shown in contact with floor 1606. For example, wheel 1602 may be a castored idler wheel of forklift 302 that engages floor 1606 when forks 306 are in a lowered position. As forklift 302 moves around in its workspace, such as along axis 1608, wheel 1602 turns. The turning of wheel 1602 drives generator 1604 to generate energy, such as in an electromagnetic energy generation fashion, as would be understood by persons skilled in the relevant art(s). The generated energy can be stored in energy storage device 404.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for providing power to a radio frequency identification (RFID) reader on a mobile structure, comprising:
generating energy at the mobile structure;
charging an energy storage device disposed on the mobile structure with the generated energy; and
powering the RFID reader with the energy storage device.

2. The method of claim 1, wherein said generating comprises:
(a) generating the energy from vibration of the mobile structure during operation of the mobile structure.

3. The method of claim 2, wherein step (a) comprises:
generating the energy with a piezoelectric transducer mounted to the mobile structure.

4. The method of claim 1, wherein said generating comprises:
generating energy produced by relative movement of a magnet and a coil that are mounted to the mobile structure.

5. The method of claim 1, wherein said generating comprises:
converting light received at the mobile structure into energy.

6. The method of claim 1, wherein said converting light comprises:
converting light received at the mobile structure into energy using an optical-to-electrical transducer.

7. The method of claim 1, wherein said generating comprises:
converting heat generated by operation of the mobile structure into energy.

8. The method of claim 1, wherein said generating comprises:
converting friction caused by operation of the mobile structure into energy.

9. The method of claim 1, wherein said generating comprises:
generating energy produced by rotation of a wheel mounted to the mobile structure.

10. The method of claim 1, further comprising:
operating the mobile structure in a warehouse.

11. The method of claim 1, wherein the mobile structure is a forklift, wherein said operating comprises:
operating the forklift in the warehouse.

12. A system for providing power to a radio frequency identification (RFID) reader on a mobile structure, comprising:
an energy storage device disposed on the mobile structure and coupled to the reader; and
an energy harvesting device disposed on the mobile structure that generates energy;
wherein the energy storage device stores the generated energy.

13. The system of claim 12, wherein the mobile structure is a forklift.

14. The system of claim 12, wherein said energy harvesting device comprises:
a vibratory energy harvesting device that generates the energy from vibration of the mobile structure during operation of the mobile structure.

15. The system of claim 14, wherein said vibratory energy harvesting device comprises:
a piezoelectric transducer.

16. The system of claim 15, further comprising:
a moment arm that mounts the piezoelectric transducer; and
a capacitor coupled to the energy storage device;
wherein vibration of the arm causes the arm to deflect the piezoelectric transducer;
wherein the piezoelectric transducer generates a current due to the deflection, and
wherein the current charges the capacitor.

17. The system of claim 12, wherein said energy harvesting device comprises:
a magnetic energy harvesting device.

18. The system of claim 17, wherein said magnetic energy harvesting device comprises:
a magnet; and
a coil;
wherein the energy is generated by movement of the magnet through the coil.

19. The system of claim 12, wherein said energy harvesting device comprises:
an optical-to-electrical transducer that converts light received at the mobile structure into energy.

20. The system of claim 12, wherein said energy harvesting device comprises:
a heat energy harvesting device that converts heat generated by operation of the mobile structure into energy.

21. The system of claim 12, wherein said energy harvesting device comprises:
a mechanical energy harvesting device that converts heat generated by operation of the mobile structure into energy.

22. The system of claim 21, wherein the mobile structure is a forklift, wherein said mechanical energy harvesting device comprises:
a generator mounted to a telescoping riser of the forklift;
wherein the generator has an interface with a fork portion of the forklift, wherein the generator generates energy from friction between the generator interface and the fork portion of the forklift.

23. The system of claim 21, wherein the mobile structure is a forklift, wherein said mechanical energy harvesting device comprises:
a generator mounted to the forklift and coupled to a wheel of the forklift;
wherein the generator generates energy from turning of the wheel during movement of the forklift.
